(19) United States
(12) Patent Application Publication
(10) Pub. No.: US 2012/0158386 A1
(43) Pub. Date: Jun. 21, 2012

(54) METHOD FOR THE INSPECTION OF THE MODELING OF TECHNICAL SYSTEMS

(76) Inventors: Thomas Ehben, Friedeburg (DE); Nasser Jazdi, Renningen (DE); Camelia Maga, Ludwigsburg (DE); Thilo Tetzner, Nurnberg (DE)

(21) Appl. No.: 13/392,752

(22) PCT Filed: Jul. 29, 2010
(86) PCT No.: PCT/EP2010/061003

§ 371 Date: Feb. 27, 2012

(30) Foreign Application Priority Data
Aug. 26, 2009 (DE) 10 2009 038 882.6

(51) Int. Cl. G06F 17/50

(52) U.S. Cl. 703/6

(57) ABSTRACT

Methods and engineering systems for the automatic inspection of the modeling of technical systems in an engineering or design process, wherein the used description language (e.g., UML or SysML) is extended by suitably defined stereotypes, especially suitable for the automatic detection of incompatibilities in the formation or variants of technical systems or products.

### CROSS-REFERENCE TO RELATED APPLICATIONS

This application is a U.S. National Stage Application of International Application No. PCT/EP2010/061003 filed Jun. 29, 2010, which designates the United States of America, and claims priority to DE Patent Application No. 10 2009 038 882.6 filed Aug. 26, 2009. The contents of which are hereby incorporated by reference in their entirety.

### TECHNICAL FIELD

The present disclosure relates to methods and systems for the inspection of the modeling of technical systems within the engineering or design process for technical systems.

### BACKGROUND

Technical systems or solutions are frequently characterized by a mixture of reused development services and individual variants. Pre-prepared features, which can be combined according to specific rules to create an individual variant of the system, are frequently held in readiness for the realization of a construct.

From the software industry the presentation standard “FODA” (Feature Oriented Domain Analysis) of the SEI (Software Engineering Institute) of the Carnegie Mellon University in the USA is known (Kang, K.; Cohen, S.; Hess, J. A.; Novak, W. E.; Peterson, S. A.: Feature Oriented Domain Analysis (FODA) Feasability Study. Technical Report, Software Engineering Institute (SEI), Carnegie-Mellon University, 1990), but this is not widely used and only inadequately supports the presentation of variants of technical systems or technical components, since it was developed for the demands of the software industry.

A further variant description, likewise designed for software development, is provided by what are known as variation points. This connects a combination syntax inspired by FODA with a graphical representation of the application cases connected thereto (Pohl, Böckle, van der Linden: Software Product Line Engineering, 2000).

For systems and solutions which extend beyond software the description language SysML of the OMG (Object Management Group) exists. On the basis of this language simple variant formations are able to be represented, but not with simultaneous description of the explicit rules for their combinational logic. In addition they do not provide the option of presenting a complete system variant with a number of selection decisions of different features to be made, in some cases independently (http://www.omgsysml.org/).

A method for the development of components based on shared and different design variants is published in patient application US2007/0073429A1.

### SUMMARY

In one embodiment, a method for automatic inspection of the modeling of technical systems, especially of technical plants, with an engineering or design process is provided. The method may include (a) Modeling of the system in an, especially graphical, system description language through input and output means, wherein system components are represented by first elements of the system description language, wherein relationships between the system components or between the system components and an environment are represented by second elements of the system description language, wherein definable rules are available for the combination of system components with each other and for the modeling of relationships between system components, and wherein the rules represent requirements for a technology and/or a sector and/or a domain to be used; and (b) automatic checking by a checking unit, as to whether the modeled system is compatible with the defined rules.

In a further embodiment, the method further includes (c) Display of incompatibilities in the modeling on the output means. In a further embodiment, the method is integrated into a modeling application or a modeling environment. In a further embodiment, the method is realized as a standalone application. In a further embodiment, the modeling is undertaken in the description language SysML or UML. In a further embodiment, the first and second elements of the system description language are formed by stereotypes of the description language SysML or UML. In a further embodiment, the system components, the relationships between them and the rules are mapped in a common data format, in which the compatibility checking is carried out. In a further embodiment, the method is used for modeling of variants of technical components and/or products and/or systems and/or plants. In a further embodiment, the method is used for modeling of technical components and/or products and/or systems and/or plants. In a further embodiment, for automatic checking, the datasets to be checked are provided to the checking unit as a file or data stream via a network connection as a standardized data interchange format, especially XML and the checking is carried out with a standard parser.

In another embodiment, a system, especially an engineering system or a software development environment, is provided to carry out a method for automatic inspection of the modeling of technical systems, especially of technical plants, which may include (a) Modeling of the system in an, especially graphical, system description language through input and output means, wherein system components are represented by first elements of the system description language, wherein relationships between the system components or between the system components and an environment are represented by second elements of the system description language, wherein definable rules are available for the combination of system components with each other and for the modeling of relationships between system components, and wherein the rules represent requirements for a technology and/or a sector and/or a domain to be used; and (b) automatic checking by a checking unit, as to whether the modeled system is compatible with the defined rules.

### BRIEF DESCRIPTION OF THE DRAWINGS

Example embodiments will be explained in more detail below with reference to figures, in which:

FIG. 1 shows an optional feature of a SysML block, according to an example embodiment;

FIG. 2 shows a required feature of a SysML block, according to an example embodiment;

FIG. 3 shows an alternative feature of a SysML block, according to an example embodiment;

FIG. 4 shows a selected feature of a SysML block (variant with “or”), according to an example embodiment;

FIG. 5 shows a selected feature of a SysML block (variant with “choice”), according to an example embodiment;

FIG. 6 shows an optional feature of a SysML package, according to an example embodiment;

FIG. 7 shows a required feature of a SysML package, according to an example embodiment;

FIG. 8 shows an alternative feature of a SysML package, according to an example embodiment;

FIG. 9 shows a selected feature of a SysML package (variant with “or”), according to an example embodiment;

FIG. 10 shows a selected feature of a SysML package (variant with “choice”), according to an example embodiment;

FIG. 11 shows an example flow diagram for carrying out the method, according to an example embodiment; and

FIG. 12 shows an example system for realizing the method, according to an example embodiment.

### DETAILED DESCRIPTION

Some embodiments provide methods and systems for inspecting possible variants in the modeling of technical systems, wherein the inspection is based on a general standard and is applied across technologies or in an interdisciplinary manner.

In some embodiments, a method for automatic inspection of the modeling of technical systems, e.g., technical plants, within an engineering or design process, is provided. The method may include (a) Modeling (M) of the system in an, especially graphical system description language, through input and output means, wherein system components are represented by first elements (EE1-EE23) of the system description language, wherein relationships between the system components and an environment are represented by second elements (ZE1-ZE10) of the system description language, wherein definable rules are available for the combination of system components with one another and for the modeling of relationships between system components, and wherein the rules represent requirements of a technology to be used and/or of a sector and/or of a domain; and (b) automatic inspection (P) by an inspection unit as to whether the model system is compatible with the defined rules. The method may make possible a formalizable spectrum of possible combinations of components of technical systems or products and possible component or product variants. The combination of system features may specify an individual system variant while the rules which each combination must satisfy may be predetermined by the technology used and/or requirements of the respective sector or domain. For example it may be possible for the buyer of an automobile to decide on the diesel or gasoline variant of an engine while the number “one” of the engine for his vehicle is predetermined by the design of motor vehicles in general. Standard software tools are able to be used for the method, such as CAx tools, PLM tools or engineering tools for product or plant design. An example of a rule is a minimum scope of features. Checking for adherence to this rule may then ensure completeness of the feature set.

In a further embodiment, the method may further include displaying on output means incompatibilities in the modeling. An operator may be notified (e.g., immediately) about incompatibilities in the modeling (e.g. when combining unsuitable components, e.g., the combination of an electric motor with an exhaust) and receives a warning. The detection of incompatibilities at an earlier phase of the planning process may avoid expensive changes later.

In a further embodiment, the method may be integrated into a modeling application or modeling environment. This may provide for detection of incompatibilities in an early phase of the planning process during the use of the method in a modeling application.

In a further embodiment, the method may be realized as a standalone application. The method can thus be integrated into both a modeling application or modeling environment but can also be used as a standalone application (e.g., as a desktop application).

In a further embodiment, the modeling may be undertaken in the description language SysML or UML. SysML and UML are widely-used standard languages for the modeling of products or systems and are not just able to be used for pure software projects. FODA for example is very specific and not widely used. Furthermore the use of SysML or UML may ensure that there is no tool discontinuity or method discontinuity, since SysML or UML are used ever more frequently in any event as design tools.

In a further embodiment, the first and second elements of the system description language may be formed by stereotypes of the description language SysML or UML. The stereotypes construct makes possible a simple expandability of the description language, flexibly tailored or able to be adapted to respective requirements (e.g. domains, sectors, products) and peripheral conditions (e.g. project requirements).

In a further embodiment, the system components, the relationships between the system components and the rules may be mapped to a common data format in which the compatibility checking is carried out. This may facilitate automatic compatibility checking. XMI (XML Metadata Interchange) can be used for example as the data format, allowing checking by commercially available XML-parsers. XMI is a widely used interchange format for UML or SysML models.

In a further embodiment, the method may be used for modeling variants of technical components and/or products and/or systems and/or plants. This may make a formalizable variant formation and presentation possible.

In a further embodiment, the method may be used for modeling of technical components and/or products and/or systems and/or plants. This may make a formalizable checking of the modeling and presentation of variants or variations of technical components and/or product and/or systems and/or plants possible.

In a further embodiment, the datasets to be inspected may be provided for automatic inspection as a file or data stream over a network connection of the test unit as a standardized data interchange format, e.g., XML, and the inspection may be carried out with a standard parser. The inspection is thus not restricted to specific or proprietary data formats and can be carried out with commercially available tools (e.g. standard parsers for XML).

Some embodiments provide an engineering system or a software development environment for carrying out any of the methods discussed herein. For example, standard tools from Stange (commercial off the shelf) can be used, such as CAx tools, PLM tools (PLM stands for Product Lifecycle Management), engineering tools, or customized tools for example. The integration of the method into an available engineering system may ensure that no method and media discontinuity occurs. In some embodiments, this may increase the quality and/or efficiency of the modeling or of the modeling results. The language element stereotype is an expansion of existing model elements of a description language which supports stereotypes such as e.g. Unified Modeling Language (UML) or Systems Modeling Language (SysML). In practice stereotypes primarily specify the possible usage situations, (usage context) of a class, a relationship or a package. A stereotype specifies how a metaclass already specified by the metamodel of the UML can be adapted for a specific area of use. Stereotypes are able to be created or adapted, i.e., formalized for specific domains, sectors or products. Rules for the combination of components of these domains, sectors or products can further be defined and formalized by stereotypes. UML or SysML models can be mapped to data formats (e.g. XML or XMI), which makes possible automatic checking of the incompatibilities in these data formats. The power of a description language can be specifically flexibly expanded or adapted by a user through stereotypes.

In accordance with some embodiments, a representation of system variants on the basis of the SysML or UML description language is proposed. This may be achieved by an enrichment of SysML or UML by additionally defined stereotypes. The power of these description languages may make it possible to define additional stereotypes in order to expand the language scope able to be used by a user. In principle the method can be applied to any description language which offers stereotypes or similar constructs. Stereotypes allow rules for arrangement and combination (e.g. aggregation) of language elements to be defined, which make possible a syntactic and semantic inspection of a model created with the description language. A user may be notified automatically in this case (online or in batch mode) of incompatibilities of the model. Batch mode may be especially suitable for modeling large systems consisting of many subsystems and in which many modelers (e.g. system architects) are involved. After merging of the part models an inspection for incompatibilities can be carried out in batch mode.

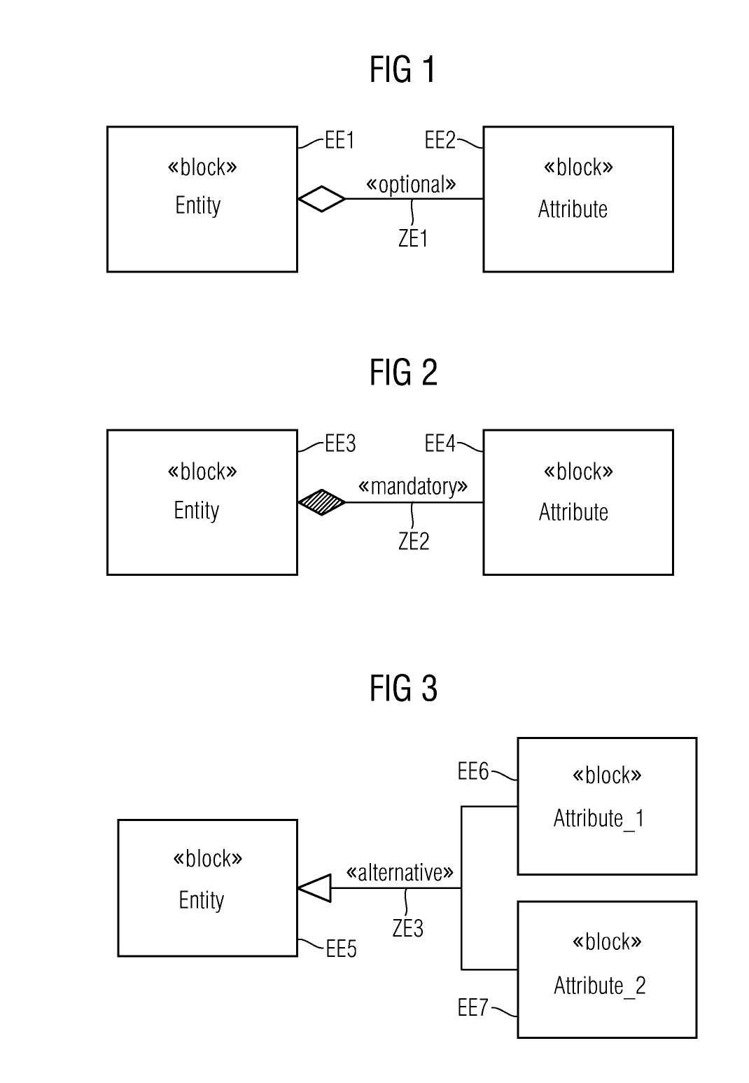

In FIGS. 1 to 10 respective presentation types for the formation of variants based on blocks and packages are proposed, according to certain example embodiments. Blocks and packages are fixed components of the SysML or of the UML language scope and well known as such to a system modeler (e.g. system architect). In principle the modeling methods disclosed herein may be able to be carried out with any or all description languages which allow the stereotype language construct or the like. FIGS. 1 to 5 show a variant presentation based on the blocks language constructs, according to certain example embodiments. FIGS. 6 to 10 show a variant presentation based on the packages language constructs, according to certain example embodiments.

FIG. 1 shows an “optional feature” of a SysML or UML block. An optional feature of an entity is represented in each case by a SysML block for the entity EE1 and its feature EE2. The relationship between entity and feature is represented by a new SysML stereotype ZE1, which is based on the aggregation symbol and is supplemented by the additional text “optional”.

FIG. 2 shows a “mandatory feature” of a SysML or UML block, according to an example embodiment. A mandatory feature of an entity is represented in each case by a SysML block for the entity EE3 and its feature EE4. The relationship between entity and feature is represented by a new SysML stereotype ZE2, which is based on the symbol for a composition and is supplemented by the additional text “mandatory”.

FIG. 3 shows an “alternative feature” of a SysML or UML block, according to an example embodiment. An alternative feature of an entity (precisely one feature from a set of possible features) is represented by a SysML block for the entity EE5 and a respective block EE6, EE7 for two or more possible variants, of which precisely one can be selected. The relationship between entity EE5 and feature EE6, EE7 is represented by a new SysML stereotype ZE3 which is based on the symbol for a generalization (inheritance) and is supplemented by the additional text “alternative”.

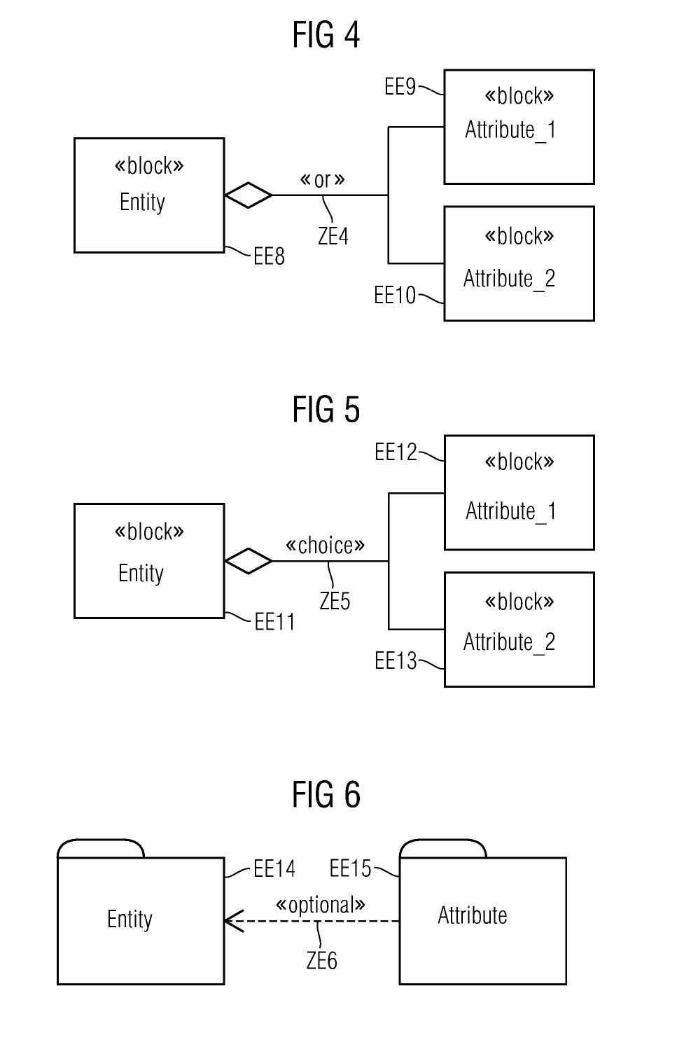

FIG. 4 shows a “selected feature” of a SysML or UML block (variant with “or”), according to an example embodiment. A selected feature of an entity (a feature or a number of features from a set of possible features) is represented by a SysML block EE8 for the entity and by a block EE9, EE10 in each case for the two or more possible variants, from which one or more can be selected. The relationship between entity and feature is represented by a new SysML stereotype ZE4, which is based on the symbol for an aggregation and is supplemented by the additional text “or”.

FIG. 5 shows a “selected feature” of a SysML or UML block (variant with “choice”), according to an example embodiment. A selected feature of an entity (a feature or a number of features from a set of possible features) is represented by a SysML block EE11 for the entity and one block EE12, EE13 for two or more possible variants from which one or more can be selected. The relationship between entity and feature is represented by a new SysML stereotype ZE5, which is based on the symbol for an aggregation and is supplemented by the additional text “choice”.

FIGS. 6 to 10 show examples for presentation of variants based on packages.

FIG. 6 shows an “optional” feature” of a SysML package or UML package, according to an example embodiment. An optional feature of an entity is represented by a SysML package or UML package in each case for the entity and its feature. The relationship between entity EE14 and feature EE15 is represented by a new SysML stereotype ZE6, which is based on the symbol for an element import or package import and is supplemented by the additional text “optional”.

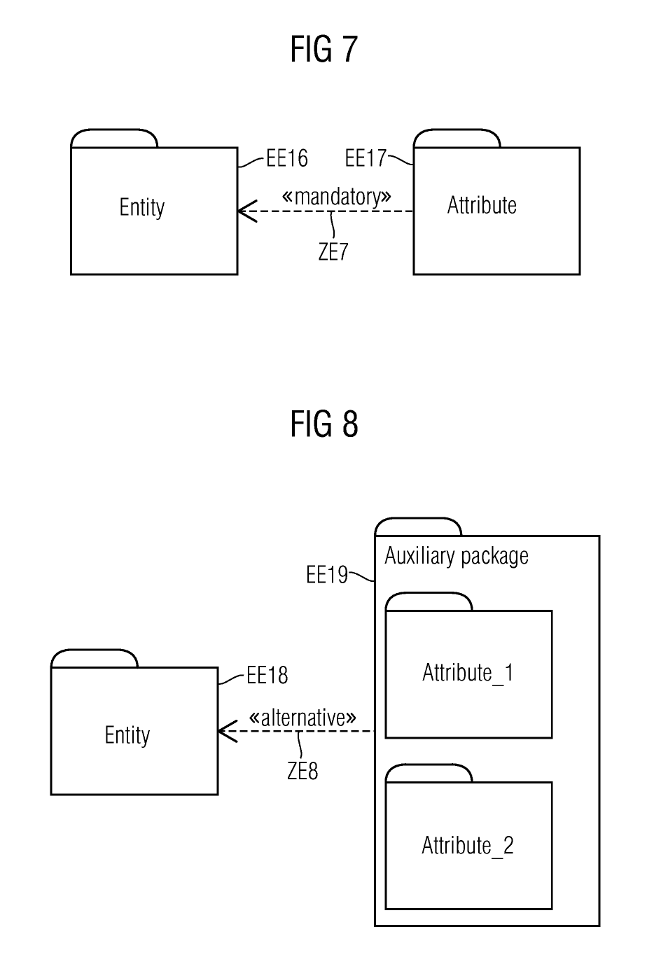

FIG. 7 shows a “mandatory feature” of a SysML package or UML package, according to an example embodiment. A mandatory feature of an entity is represented by a SysML or UML package in each case for the entity EE16 and its feature EE17. The relationship between entity EE16 and feature EE17 is represented by a new SysML stereotype ZE7 which is based on the symbol for an element import or package import and is supplemented by the additional text “mandatory”.

FIG. 8 shows an “alternative feature” of a SysML package or UML package, according to an example embodiment. An alternative feature of an entity (precisely one feature from a set of possible features) is represented by a SysML block EE18 for the entity and an auxiliary package EE19 which represents the set of the possible features. Within the auxiliary package EE19 its individual feature variants from which precisely one can be selected are represented as further packages. The relationship between entity EE18 and feature is represented by a new SysML stereotype ZE8 which is based on the symbol for an element import or package import and is supplemented by the additional text “xor” or “alternative”. It is located between the entity EE18 and the auxiliary package EE19.

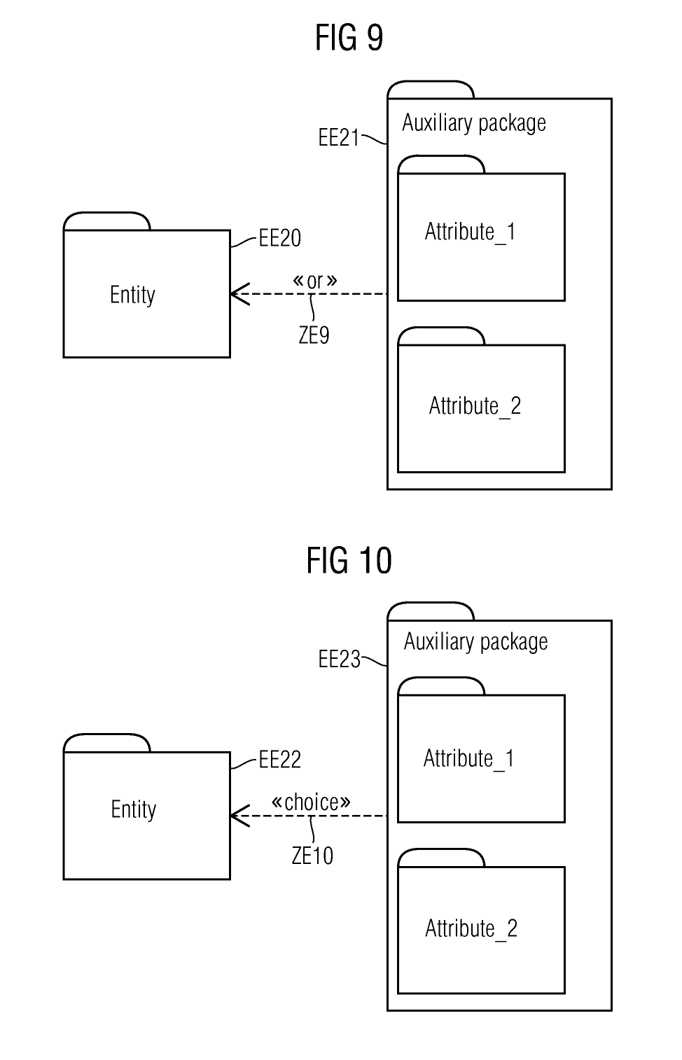

FIG. 9 shows a “selected feature” of a SysML or UML package (variant with “or”), according to an example embodiment. A selected feature of an entity (one feature or a number of features from a set of possible features) is represented by a SysML block for the entity EE20 and an auxiliary package EE21, which represents the set of possible features. Within the auxiliary package EE21 its individual feature variants from which one or more can be selected are represented as further packages. The relationship between entity EE20 and feature is represented by a new SysML stereotype ZE9 which is based on the symbol for an element import or package import and is supplemented by the additional text “or” or “choice”. It is located between the entity EE20 and the auxiliary package EE21.

FIG. 10 shows a “selected feature” of a SysML or UML package (variant with “choice”), according to an example embodiment. A selected feature of an entity (one feature or a number of features from a set of possible features) is represented by a SysML block for the entity EE22 and an auxiliary package EE23 which represents the set of possible features. Within the auxiliary package EE23 its individual feature variants from which one or more can be selected are presented as further packages. The relationship between entity EE22 and feature is represented by a new SysML stereotype ZE10 which is based on the symbol for an element import or package import and is supplemented by the additional text “or” or “choice”. It is located between the entity EE22 and the auxiliary package EE23.

Further, in addition to the stereotype expansions in English, translations in the respective national language of the user may be employed.

As well as the relationship attributes “optional”, “mandatory”, “alternative” or “choice”, further cross references “Required”, “Recommended”, “Forbids”, “Discourages” or “Influences” can also be described by additional stereotypes with corresponding texts in conjunction with “Usage” relationships. In some embodiments, the language expansions may be especially advantageous since they are not only applicable to software systems but are also simple and generally-understandable and are based on recognized and widely-used description languages such as SysML or UML. The use of the term “alternative” in the wider sense also makes an exclusive choice from basic sets with more than two features possible. Furthermore the proposed language expansion also makes possible a tool-supported inspection of selection decisions for system features which are made during the system specifications. In some embodiments, the visual description languages may represent a complete system variant at the same time as selection options of different features.

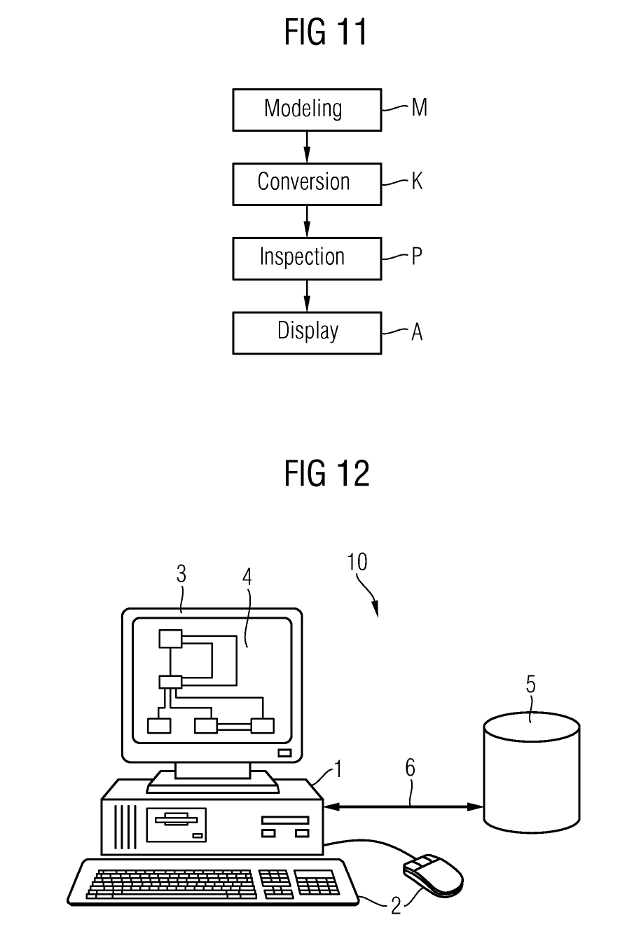

FIG. 11 shows a typical flow diagram for carrying out the method for modeling of technical systems within an engineering or design process, according to an example embodiment. In the step modeling M the (usually graphical or tabular) description of the technical system (production plant, machine, robots etc) of a product (camcorder, vehicle etc) or of a technical problem to be solved (e.g. efficient energy transmission from a generator to a consumer). The modeling is undertaken in a suitable description language (e.g. UML, SysML) by a user (e.g. sales or automation engineer) through input and output means at a computer (e.g. laptop, PC). Through the language element stereotype rules are able to be defined in the description language for merging and for combination of objects. The description language is able to be expanded by a user for specific sectors, domains or products. Thus a sector, domain or product specific variant formation can be presented in a formalized manner. The formalized presentation may be a requirement for an automatic inspection P of a created model for incompatibilities.

The inspection P can be undertaken online or in batch mode. The steps conversion K and display A are optional. Conversion into a data interchange format (e.g. XML or XMI) on the one hand makes the coupling/integration to further tools (e.g. simulation programs) possible, on the other hand standard parsers exist for standardized data interchange formats (e.g. XML) for checking for incompatibilities. A graphical display A of incompatibilities in the model makes it possible for a user to immediately and explicitly correct incorrect inputs.

FIG. 12 shows a typical system 10 for realizing the method, according to an example embodiment. The method can for example be integrated by a software tool of an engineering system, a CAx tool (CAD, CAM etc.) or a PLM tool (Product Lifecycle Management) which compares an individual system variant described in SysML (or in UML or in a similar description language) with the set of selection rules as described above and informs the user whether the selected variant is compatible with the set of rules. In the event of an incompatibility it gives the user specific information or warnings on an output unit 3 (e.g., screen), as to which combinations used break which rules. Two basic architectures present themselves for the implementation of such a tool:

On the one hand integration into an existing modeling application: Here the function of the tool may be integrated into the workflow and the graphical user interface 4 of the application.

On the other hand a stand-alone application: Here the tool may exist as a self-contained application which can be started independently of other programs. It may read in the datasets to be inspected, preferably as a file or data stream via a network connection. The XMI (XML Metadata Interchange) format can be considered here as a data format.

With both architectures a user can carry out the modeling in the description language via a computer 1 with the aid of input means 2 (mouse, keyboard, etc.) at the graphical user interface 4 of an output unit 3. A database 5 may be available for archiving, which may be connected to the computer 1 (laptop, industrial PC, workstation, etc.) via a suitable data connection 6 (cable or wireless). It is also conceivable to operate the method as a Web Application Service via the Intranet or Internet.

Thus, various embodiments provide method and engineering systems for automatic inspection of the modeling of technical systems with an engineering or design process, in which the description language used (e.g. UML or SysML) may be extended by suitably defined stereotypes, e.g., suitable for automatic detection of incompatibilities in the variant formation of technical systems or products.

### LIST OF REFERENCE CHARACTERS

EE1-EE23 First element of the description language
ZE1-ZE10 Second element of the description language
M Method step
K Method step
P Method step
A Method step
10 System
1 Computer
2 Input means
3 Output means
4 User interface
5 Database
6 Connection

What is claimed is:

1. A method for automatic inspection of the modeling of a technical system with an engineering or design process, comprising:
(a) modeling the technical system in a system description language through input and output means,
wherein system components are represented by first elements of the system description language,
wherein relationships between the system components or between the system components and an environment are represented by second elements of the system description language,
wherein definable rules are available for the combination of system components with each other and for the modeling of relationships between system components, and
wherein the rules represent requirements for at least one of a technology, a sector, and a domain to be used; and
(b) automatically checking, by a checking unit, whether the modeled technical system is compatible with the defined rules.

2. The method of claim 1, further comprising:
(c) displaying incompatibilities in the modeling on the output means.

3. The method of claim 1, wherein the method is integrated into a modeling application or a modeling environment.

4. The method of claim 1, wherein the method is realized as a standalone application.

5. The method of claim 1, wherein the modeling is undertaken in the description language SysML or UML.

6. The method of claim 1, wherein the first and second elements of the system description language are formed by stereotypes of the description language SysML or UML.

7. The method of claim 1, wherein the system components, the relationships between them and the rules are mapped in a common data format, in which the compatibility checking is carried out.

8. The method of claim 1, wherein the method is used for modeling at least one of technical components, products, systems, and plants.

9. The method of claim 1, wherein the method is used for modeling at least one of technical components, products, systems, and plants.

10. The method of claim 1, wherein, for automatic checking, the datasets to be checked are provided to the checking unit as a file or data stream via a network connection as a standardized data interchange format, especially XML and the checking is carried out with a standard parser.

11. A system for automatic inspection of the modeling of a technical system with an engineering or design process, the system comprising:
a modeling application embodied in non-tangible computer-readable media and executable by one or more processors to model the technical system in a system description language through input and output means,
wherein system components are represented by first elements of the system description language,
wherein relationships between the system components or between the system components and an environment are represented by second elements of the system description language,
wherein definable rules are available for the combination of system components with each other and for the modeling of relationships between system components, and
wherein the rules represent requirements for at least one of a technology, a sector, and a domain to be used; and
a checking unit embodied in non-tangible computer-readable media and executable by one or more processors to automatically check whether the modeled technical system is compatible with the defined rules.

12. The system of claim 11, further comprising a display device configured to display incompatibilities in the modeling on the output means.

13. The system of claim 11, wherein the modeling application is a standalone application.

14. The system of claim 11, wherein the modeling application uses the system description language SysML or UML.

15. The system of claim 11, wherein the first and second elements of the system description language are formed by stereotypes of the description language SysML or UML.

16. The system of claim 11, wherein the system components, the relationships between them and the rules are mapped in a common data format, in which the compatibility checking is carried out.

17. The system of claim 11, configured for modeling of variants of at least one of technical components, products, systems, and plants.

18. The system of claim 11, configured for modeling of at least one of technical components, products, systems, and plants.

19. The system of claim 11, wherein, for automatic checking, the datasets to be checked are provided to the checking unit as a file or data stream via a network connection as a standardized data interchange format, especially XML and the checking is carried out with a standard parser.
